(19) United States
(12) Patent Application Publication
(10) Pub. No.: US 2024/0212305 A1
(43) Pub. Date: Jun. 27, 2024

(54) IMAGING SYSTEM, IMAGING DEVICE, INFORMATION PROCESSING SERVER, IMAGING METHOD, INFORMATION PROCESSING METHOD, AND STORAGE MEDIUM

(71) Applicant: CANON KABUSHIKI KAISHA, Tokyo (JP)

(72) Inventor: Ryosuke TSUJI, Kanagawa (JP)

(21) Appl. No.: 18/595,686

(22) Filed: Mar. 5, 2024

Related U.S. Application Data
(63) Continuation of application No. PCT/JP2022/037120, filed on Oct. 4, 2022.

(30) Foreign Application Priority Data
Oct. 14, 2021 (JP) 2021-168738

(51) Int. Cl. G06V 10/25; G06T 5/50

(52) U.S. Cl. CPC G06V 10/25; G06T 5/50; G06T 2207/20221; G06V 2201/07

(57) ABSTRACT

An imaging system that performs object detection on the basis of a neural network includes: training data inputting unit configured to input training data for the object detection; network structure designation unit configured to designate a restriction of a network structure in the object detection; dictionary generation unit configured to generate dictionary data for the object detection on the basis of the training data and the restriction of the network structure; and an imaging device configured to perform the object detection on the basis of the dictionary data generated by the dictionary generation unit and performs predetermined imaging control on an object detected through the object detection.

### BACKGROUND OF THE INVENTION

### Field of the Invention

The present invention relates to an imaging system, an imaging device, an information processing server, an imaging method, an information processing method, and a storage medium using a neural network.

### Description of the Related Art

Object detection is one of fields of computer vision research that has already been widely studied. Computer vision is a technology of understanding an image input to a computer and automatically recognizing various characteristics of the image. In the technology, object detection is a task of estimating a position and a type of an object that is present in a natural image. The object detection has been applied to an auto focusing technology and the like of an imaging device.

In recent years, an imaging device that detects an object through a machine learning method, representative examples of which include a neural network, is known. Such an imaging device uses a learned model (dictionary data) corresponding to a specific object to detect the specific object and perform imaging control. Representative examples of the type of the specific object include a person, an animal such as a dog or a cat, and a vehicle such as an automobile, and the specific object is an object that has a high need of an auto focusing function of the imaging device.

Japanese Unexamined Patent Application, Publication No. 2011-90410 discloses an image processing device that receives dictionary data for recognizing an object that is present at a predetermined location from a server device. Although the dictionary data is switched in accordance with a situation, an arbitrary specific object of a user is not detectable according to the configuration.

Also, Japanese Unexamined Patent Application, Publication No. 2011-90413 discloses an image processing device that realizes an object detector that is suitable for a user through additional learning. It is difficult to detect an arbitrary new object of the user since it is based on additional learning. Also, although a situation in which an image processing device executes learning and inference is assumed, imaging devices, for example, may have different restrictions of network structures for object detection, and it may not be possible to appropriately perform additional learning.

### SUMMARY OF THE INVENTION

An aspect of the present invention provides an imaging system that performs object detection on the basis of a neural network, the imaging system comprising: at least one processor or circuit configured to function as: training data inputting unit configured to input training data for the object detection; network structure designation unit configured to designate a restriction of a network structure in the object detection; dictionary generation unit configured to generate dictionary data for the object detection on the basis of the training data and the restriction of the network structure; and an imaging device configured to perform the object detection on the basis of the dictionary data generated by the dictionary generation unit and performs predetermined imaging control on an object detected through the object detection.

Further features of the present invention will become apparent from the following description of Embodiments with reference to the attached drawings.

### BRIEF DESCRIPTION OF THE DRAWINGS

FIG. 1 is a configuration diagram of an imaging system according to a first embodiment of the present invention.

FIG. 2 is a block diagram illustrating a configuration example of an imaging device 100 according to the first embodiment.

FIG. 3 is a block diagram illustrating a schematic configuration of a neural network processing unit 205 according to the first embodiment.

FIG. 4 is a diagram illustrating an example of restriction conditions from a viewpoint of a network structure.

FIG. 5 is a block diagram illustrating a hardware configuration example of a server 110.

FIG. 6 is a block diagram illustrating a hardware configuration example of a mobile terminal 120.

FIG. 7 is a flowchart illustrating processing of the imaging device according to the first embodiment.

FIGS. 8A and 8B are diagrams for explaining an example of object detection based on dictionary data.

FIG. 9 is a flowchart illustrating processing of the server according to the first embodiment.

FIGS. 10A and 10B are flowcharts for explaining a flow of dictionary data generation processing according to the first embodiment.

FIG. 11 is a flowchart illustrating an example of a flow of processing executed by the mobile terminal 120 according to the first embodiment.

FIGS. 12A to 12D are diagrams for explaining an input screen example of training data and a network structure of a display unit 604 of the mobile terminal according to the first embodiment.

FIG. 13 is a diagram illustrating a configuration example of an imaging system according to a second embodiment.

FIG. 14 is a flowchart illustrating a processing example of an imaging device according to the second embodiment.

FIGS. 15A and 15B are diagrams for explaining imaging control before and after validation of a user custom dictionary.

FIG. 16 is a configuration diagram of an imaging system according to a third embodiment.

FIGS. 17A and 17B are flowcharts for explaining processing of an imaging device 100 according to the third embodiment.

FIG. 18 is a flowchart for explaining a flow of training data input processing in FIG. 17B.

FIGS. 19A and 19B are diagrams illustrating an example of a training data input screen in FIG. 18.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

Also, an example of an application to a digital still camera as an imaging device will be described in the embodiments. However, the imaging device includes electronic devices or the like having an imaging function, such as a digital movie camera, a smartphone equipped with a camera, a tablet computer equipped with a camera, a network camera, an in-vehicle camera, a drone camera, and a camera mounted on a robot.

### First Embodiment

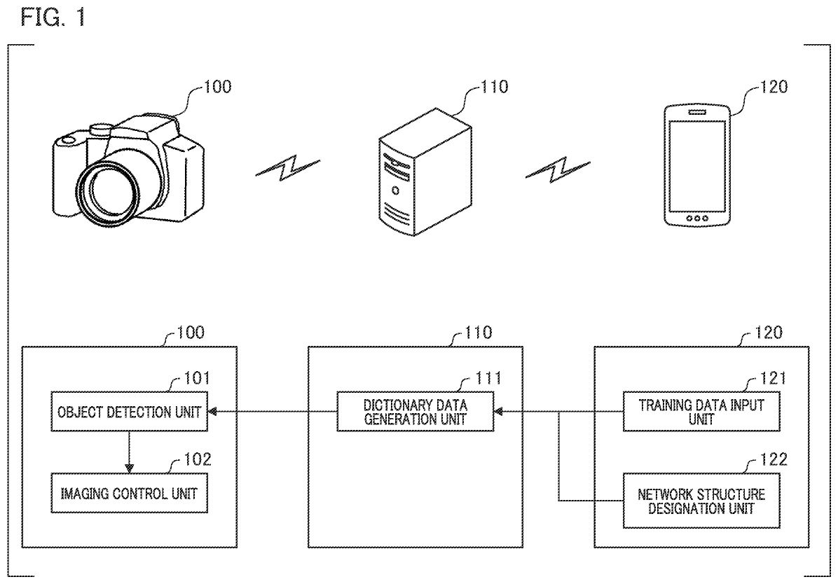

Hereinafter, an imaging system according to a first embodiment of the present invention will be described in detail. FIG. 1 is a configuration diagram of the imaging system according to the first embodiment of the present invention, and the imaging system includes an imaging device 100, a server 110 as an information processing server, a mobile terminal 120 as an information processing terminal that is different from the imaging device 100, and the like. The imaging device 100 and the server 110 are connected by a wireless communication network, for example. Also, the server 110 and the mobile terminal 120 are connected by a wireless communication network, for example.

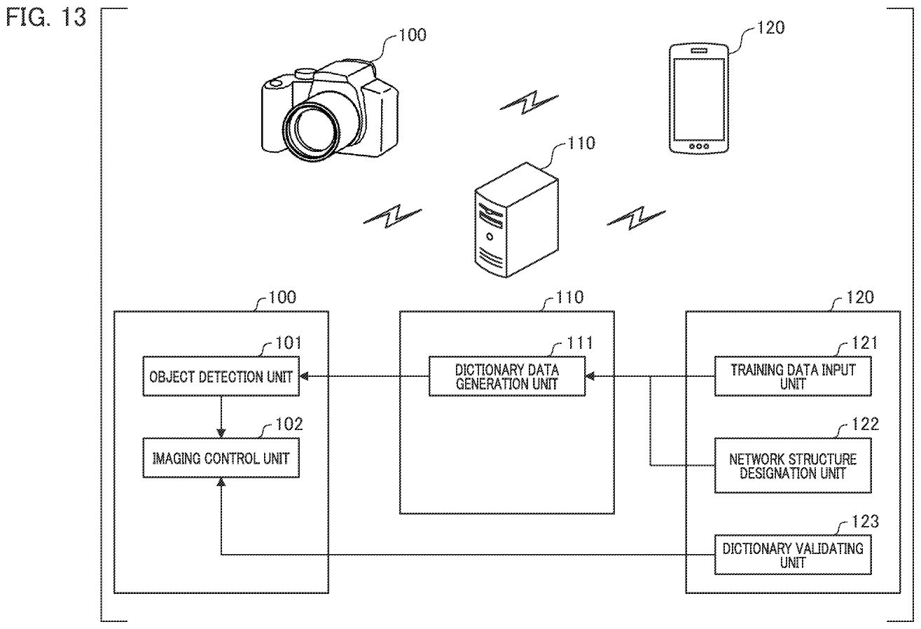

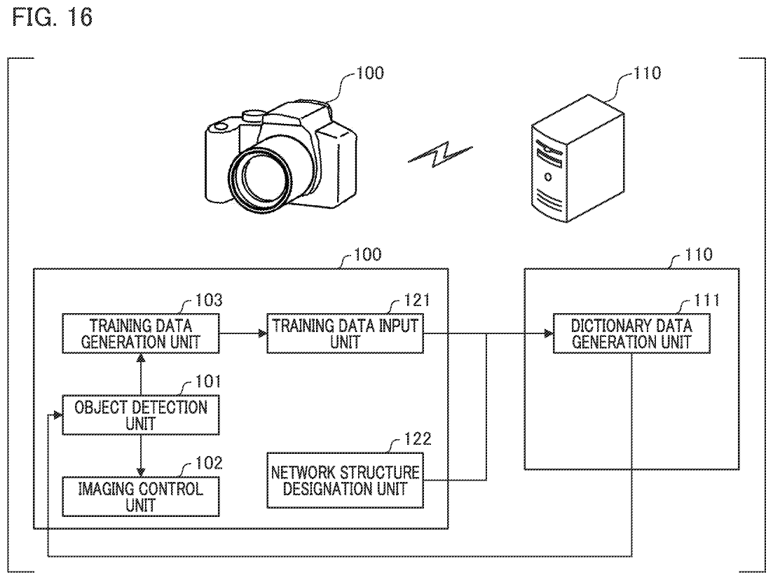

Note that each functional block in the server 110 and the mobile terminal 120 illustrated in FIG. 1 is realized by causing a computer included in each of the server 110 and the mobile terminal 120 to execute computer programs stored in a memory as a storage medium. Note that this also applies to FIGS. 13, 16, and the like which will be described later.

The imaging system according to the first embodiment performs object detection on the basis of a neural network and can detect an arbitrary object of a user. As a representative method for the object detection, there is a method called a convolutional neural network (hereinafter abbreviated as “CNN”). According to the CNN, inference processing is executed on the basis of an image signal and dictionary data which is a processing parameter, and the dictionary data is generated in advance through learning processing based on training data.

In the imaging system according to the first embodiment, the mobile terminal 120 includes a training data input unit 121 as training data inputting means for inputting training data for object detection. Also, the training data input unit 121 executes a training data inputting step of inputting training data for object detection.

Also, a plurality of sets of training data including training data, image data, and object region information of the image data where a target object is present as each set can be input to the training data input unit 121, and the training data input unit 121 can transmit the plurality of sets to the server 110.

The server 110 acquires the training data transmitted from the mobile terminal 120 and generates dictionary data by a dictionary data generation unit 111 on the basis of the acquired training data. The generated dictionary data is transmitted to the imaging device 100. In the first embodiment, the dictionary data generation unit 111 as the dictionary generation means is provided in the server 110 as an information processing server which is different from the imaging device.

The imaging device 100 receives dictionary data transmitted from the server 110 and performs inference processing based on a neural network by an object detection unit 101 on the basis of the received dictionary data. Then, the imaging control unit 102 executes imaging control such as auto focusing on the basis of a result of the inference. In other words, the imaging device 100 performs object detection on the basis of the dictionary data and performs predetermined imaging control (auto focusing, exposure control, and the like) on an object detected through the object detection.

There may be a case where a restriction of a network structure in the object detection differs depending on a model of the imaging device 100. In such a case, dictionary data also differs in accordance with restriction of the network structure. Thus, the mobile terminal 120 is provided with a network structure designation unit 122 as a network structure designation means. The network structure designation unit 122 designates a restriction condition or the like of the network structure as information related to the network structure by designating a model name, an ID, or the like of the imaging device and transmits the information to the server 110.

In other words, the network structure designation unit 122 executes a network structure designation step of designating the information related to the network structure. The dictionary data generation unit 111 in the server 110 generates dictionary data for the object detection on the basis of the training data and the information related to the network structure.

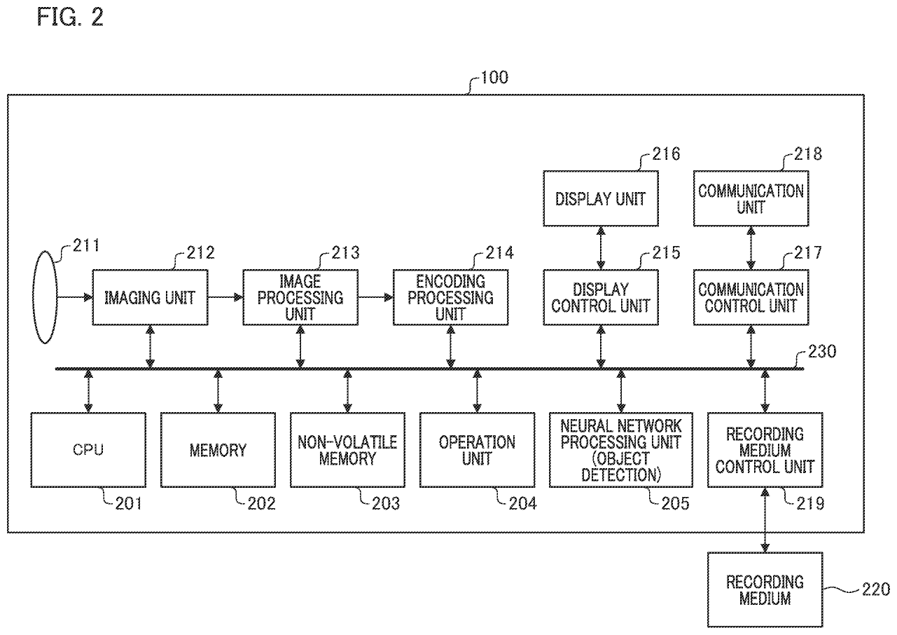

FIG. 2 is a block diagram illustrating a configuration example of the imaging device 100 according to the first embodiment. As illustrated in FIG. 2, the imaging device 100 includes a CPU 201, a memory 202, a non-volatile memory 203, an operation unit 204, a neural network processing unit 205, an imaging unit 212, an image processing unit 213, and an encoding processing unit 214. Furthermore, the imaging device 100 includes a display control unit 215, a display unit 216, a communication control unit 217, a communication unit 218, a recording medium control unit 219, and an internal bus 230.

Also, the imaging device 100 forms an optical image of an object on a pixel array of the imaging unit 212 by using an imaging lens 211, and the imaging lens 211 may be non-detachable or may be detachable from a body (a casing, a main body) of the imaging device 100. Also, the imaging device 100 performs writing and reading of image data on a recording medium 220 via the recording medium control unit 219, and the recording medium 220 may be detachable or may be non-detachable from the imaging device 100.

The CPU 201 controls operations of each component (each functional block) of the imaging device 100 via the internal bus 230 by executing computer programs stored in the non-volatile memory 203.

The memory 202 is a rewritable volatile memory. The memory 202 temporarily records computer programs for controlling operations of each component of the imaging device 100, information such as parameters related to the operations of each component of the imaging device 100, information received by the communication control unit 217, and the like. Also, the memory 202 temporarily records images acquired by the imaging unit 212 and images and information processed by the image processing unit 213, the encoding processing unit 214, and the like. The memory 202 has a sufficient storage capacity for temporarily recording them.

The non-volatile memory 203 is an electrically erasable and recordable memory, and an EEPROM or a hard disk, for example, is used. The non-volatile memory 203 stores computer programs for controlling operations of each component of the imaging device 100 and information such as parameters related to the operations of each component of the imaging device 100. Such computer programs realize various operations performed by the imaging device 100. Furthermore, the non-volatile memory 203 stores computer programs describing processing content of the neural network used by the neural network processing unit 205 and learned coefficient parameters such as a weight coefficient and a bias value.

Note that the weight coefficient is a value indicating a strength of connection between nodes in the neural network, and the bias is a value for giving an offset to an integrated value of the weight coefficient and input data. The non-volatile memory 203 can hold a plurality of learned coefficient parameters and a plurality of computer programs describing processing of the neural network.

Note that the plurality of computer programs describing the processing of the neural network and the plurality of learned coefficient parameters used by the aforementioned neural network processing unit 205 may be temporarily stored in the memory 202 rather than the memory 203. Note that the computer programs describing the processing of the neural network and the learned coefficient parameters correspond to the dictionary data for the object detection.

The operation unit 204 provides a user interface for operating the imaging device 100. The operation unit 204 includes various buttons, such as a power source button, a menu button, a release button for image capturing, a video recording button, and a cancel button, and the various buttons are configured of switches, a touch panel, or the like. The CPU 201 controls the imaging device 100 in response to an instruction of a user input via the operation unit 204.

Note that although the case in which the CPU 201 controls the imaging device 100 on the basis of an operation input via the operation unit 204 has been described here as an example, the present invention is not limited thereto. For example, the CPU 201 may control the imaging device 100 on the basis of a request input from a remote controller, which is not illustrated, or the mobile terminal 120 via the communication unit 218.

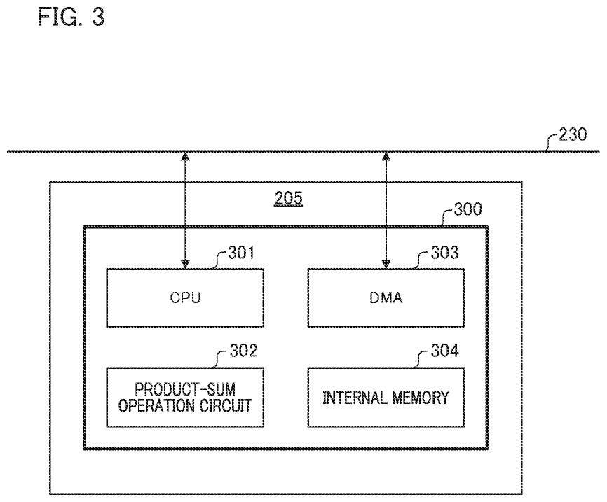

The neural network processing unit 205 performs inference processing of the object detection unit 101 based on the dictionary data. Details will be described later using FIG. 3.

The imaging lens (lens unit) 211 is configured of a lens group including a zoom lens and a focusing lens, a lens control unit, which is not illustrated, an aperture, which is not illustrated, and the like. The imaging lens 211 can function as zooming means for changing an image angle. The lens control unit of the imaging lens 211 performs adjustment of a focal point and control of an aperture value (F value) by a control signal transmitted from the CPU 201.

The imaging unit 212 can function as acquisition means for successively acquiring a plurality of images including video images. As the imaging unit 212, a charge coupled device (CCD) image sensor or a complementary metal oxide semiconductor (CMOS) image sensor, for example, is used. The imaging unit 212 includes a pixel array, which is not illustrated, in which photoelectric conversion units (pixels) that convert an optical image of an object into an electrical signal are aligned in a matrix shape, that is, in a two-dimensional manner. The optical image of the object is formed by the imaging lens 211 on the pixel array. The imaging unit 212 outputs captured images to the image processing unit 213 and the memory 202. Note that the imaging unit 212 can also acquire stationary images.

The image processing unit 213 performs predetermined image processing on image data output from the imaging unit 212 or image data read from the memory 202. Examples of the image processing include dynamic range conversion processing, interpolation processing, size reduction processing (resizing processing), color conversion processing, and the like. Also, the image processing unit 213 performs predetermined arithmetic processing such as exposure control, distance measurement control, and the like by using image data acquired by the imaging unit 212.

Also, exposure control, distance measurement control, and the like are performed by the CPU 201 on the basis of a result of the arithmetic operation obtained by the arithmetic processing performed by the image processing unit 213. Specifically, auto exposure (AE) processing, auto white balance (AWB) processing, auto focus (AF) processing, and the like are performed by the CPU 201. Such imaging control is performed with reference to a result of the object detection performed by the neural network processing unit 205.

The encoding processing unit 214 compresses the size of image data by performing intra-frame prediction encoding (intra-screen prediction encoding), intra-frame prediction encoding (intra-screen prediction encoding), and the like on image data from the image processing unit 213.

The display control unit 215 controls the display unit 216. The display unit 216 includes a display screen, which is not illustrated. The display control unit 215 generates an image that can be displayed on the display screen of the display unit 216 and outputs the image, that is, an image signal to the display unit 216. Also, the display control unit 215 can not only output image data to the display unit 216 but also output image data to an external device via the communication control unit 217. The display unit 216 displays the image on the display screen on the basis of the image signal sent from the display control unit 215.

The display unit 216 includes an on-screen display (OSD) function which is a function of displaying a setting screen such as a menu on the display screen. The display control unit 215 can superimpose an OSD image on an image signal and output the image signal to the display unit 216. It is also possible to generate an object frame on the basis of a result of the object detection performed by the neural network processing unit 205 and display it in a superimposed manner on the image signal.

The display unit 216 is configured of a liquid crystal display, an organic EL display, or the like and displays the image signal sent from the display control unit 215. The display unit 216 may include, for example, a touch panel. In a case where the display unit 216 includes a touch panel, the display unit 216 may also function as the operation unit 204.

The communication control unit 217 is controlled by the CPU 201. The communication control unit 217 generates a modulation signal adapted to a wireless communication standard such as IEEE 802.11, outputs the modulation signal to the communication unit 218, and receives a modulation signal from an external device via the communication unit 218. Also, the communication control unit 217 can transmit and receive control signals for video signals.

For example, the communication unit 218 may be controlled to send video signals in accordance with a communication standard such as High Definition Multimedia Interface (HDMI; registered trademark) or a serial digital interface (SDI).

The communication unit 218 converts video signals and control signals into physical electrical signals and transmits and receives them to and from an external device. Note that the communication unit 218 performs not only transmission and reception of the video signals and the control signals but also performs reception and the like of dictionary data for the object detection performed by the neural network processing unit 205.

The recording medium control unit 219 controls the recording medium 220. The recording medium control unit 219 outputs a control signal for controlling the recording medium 220 to the recording medium 220 on the basis of a request from the CPU 201. As the recording medium 220, a non-volatile memory or a magnetic disk, for example, is used. The recording medium 220 may be detachable or may be non-detachable as described above. The recording medium 220 saves encoded image data and the like as a file in the format adapted to a file system of the recording medium 220.

Each of functional blocks 201 to 205, 212 to 215, 217, and 219 can be accessed by each other via the internal bus 230.

Note that some of the functional blocks illustrated in FIG. 2 are realized by causing the CPU 201 as a computer included in the imaging device 100 to execute the computer programs stored in the non-volatile memory 203 or the like as a storage medium. However, some or all of them may be realized by hardware. As the hardware, it is possible to use an application specific integrated circuit (ASIC), a processor (a reconfigurable processor, a DSP), or the like.

FIG. 3 is a block diagram illustrating a schematic configuration of the neural network processing unit 205 according to the first embodiment.

The neural network processing unit 205 executes processing of the neural network by using learned coefficient parameters in advance. Note that although the processing of the neural network is configured by a fully-connected layer of the CNN, for example, the processing is not limited thereto. Also, the aforementioned learned coefficient parameters correspond to a coefficient and a bias value for each edge connecting nodes of each layer in the fully-connected layer and a weight coefficient and a bias value of kernel in the CNN.

As illustrated in FIG. 3, the neural network processing unit 205 includes, in a neural core 300, a CPU 301, a product-sum operation circuit 302, a dynamic memory access (DMA) 303, an internal memory 304, and the like.

The CPU 301 acquires the computer programs describing processing content of the neural network from the memory 202 or the non-volatile memory 203 via the internal bus 230 or from the internal memory 304 and executes the computer programs. The CPU 301 also controls the product-sum operation circuit 302 and the DMA 303.

The product-sum operation circuit 302 is a circuit that performs a product-sum operation in the neural network. The product-sum operation circuit 302 includes a plurality of product-sum operation units, and these can execute product-sum operations in parallel. Also, the product-sum operation circuit 302 outputs intermediate data calculated at the time of the product-sum operations executed in parallel by the plurality of product-sum operation units to the internal memory 304 via the DMA 303.

The DMA 303 is a circuit specialized in data transfer without intervention of the CPU 301 and performs data transfer between the memory 202 or the non-volatile memory 203 and the internal memory 304 via the internal bus 230.

Moreover, the DMA 303 also performs data transfer between the product-sum operation circuit 302 and the internal memory 304. Data transferred by the DMA 303 includes the computer programs describing the processing content of the neural network, the learned coefficient parameters, the intermediate data calculated by the product-sum operation circuit 302, and the like.

The internal memory 304 stores the computer programs describing processing content of the neural network, the learned coefficient parameters, the intermediate data calculated by the product-sum operation circuit 302, and the like. Also, the internal memory 304 may include a plurality of banks and may dynamically switch the banks.

Note that there is restriction in the capacity of the internal memory 304 and the arithmetic operation specification of the product-sum operation circuit 302, and the neural network processing is performed with the predetermined restriction met. There may be a case where the restriction conditions differ depending on the model of the imaging device, and if the restriction conditions differ, the computer programs and the learned coefficient parameters differ. In other words, dictionary data for the object detection differs.

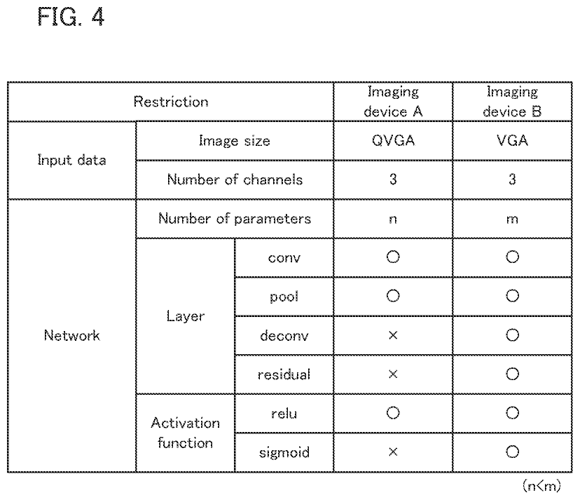

FIG. 4 is a diagram illustrating an example of restriction conditions from the viewpoint of the network structure.

In FIG. 4, the horizontal axis represents a model name of the imaging device, and the vertical axis represents information regarding the network structure, such as restriction of each network structure. Image size of input data, the number of channels of the input data, and the number of parameters of the network are restriction depending on the capacity of the memory 304, and an imaging device A has a smaller memory capacity and larger restriction than an imaging device B.

Also, the type of a layer and the type of a activation function are restriction of an arithmetic operation specification of the product-sum operation circuit 302, and the imaging device A has a smaller number of types of arithmetic operations that can be expressed and larger restriction than the imaging device B. In other words, the information related to the network structure includes information related at least one of the image size of input data, the number of channels of the input data, the number of parameters of the network, the memory capacity, the type of the layer and the type of the activation function, and the product-sum operation specification.

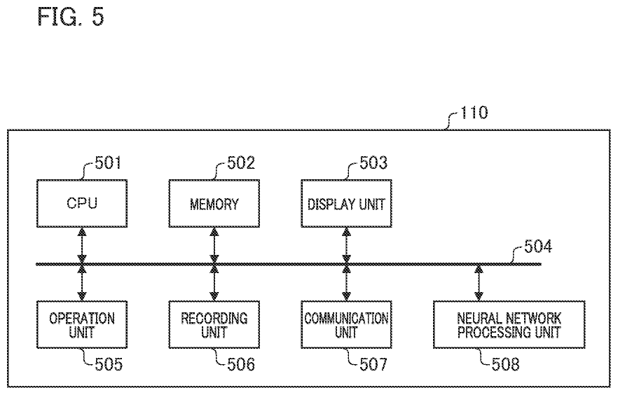

FIG. 5 is a block diagram illustrating a hardware configuration example of the server 110. As illustrated in FIG. 5, the server 110 includes a CPU 501, a memory 502, a display unit 503, an operation unit 505, a recording unit 506, a communication unit 507, and a neural network processing unit 508.

Note that some of functional blocks illustrated in FIG. 5 is realized by causing the CPU 501 as a computer included in the server 110 to execute computer programs stored in the recording unit 506 or the like as a storage medium. However, some or all of them may be realized by hardware. As the hardware, it is possible to use an application specific integrated circuit (APIC), a processor (a reconfigurable processor, a DSP), or the like.

The CPU 501 performs control of all the processing blocks configuring the server 110 by executing the computer programs stored in the recording unit 506. The memory 502 is a memory used mainly as a work area for the CPU 501 and a temporary buffer region of data. The display unit 503 is configured of a liquid crystal panel, an organic EL panel, or the like and displays an operation screen or the like on the basis of an instruction of the CPU 501.

An internal bus 504 is a bus for establishing mutual connection of each processing block in the server 110. The operation unit 505 is configured of a keyboard, a mouse, a button, a touch panel, a remote controller, and the like and receives an operation instruction from the user. Operation information input from the operation unit 505 is transmitted to the CPU 501, and the CPU 501 executes control of each processing block on the basis of the operation information.

The recording unit 506 is a processing block configured of a recording medium and storing and reading various kinds of data in and from the recording medium on the basis of an instruction form the CPU 501. The recording medium is configured of, for example, an EEPROM, a built-in flash memory, a built-in hard disk, a detachable memory card, or the like. The recording unit 506 saves, in addition to the computer programs, input data, training data, dictionary data, and the like which are data for learning in the neural network processing unit 508.

The communication unit 507 includes hardware or the like to perform communication of a wireless LAN and a wired LAN. In the wireless LAN, processing based on the IEEE 802.11n/a/g/b scheme, for example, is performed. The communication unit 507 establishes connection with an external access point through the wireless LAN and performs wireless LAN communication with other wireless communication devices via the access point.

Also, the communication unit 507 performs communication via an external router or a switching hub by using an Ethernet cable or the like in the wired LAN. The communication unit 507 performs communication with external devices including the imaging device 100 and exchanges information such as the training data and the dictionary data.

The neural network processing unit 508 selects a model of the neural network from the training data obtained via the communication unit 507 and the restriction information of the network structure acquired via the communication unit 507 and performs neural network learning processing. The neural network processing unit 508 corresponds to the dictionary data generation unit 111 in FIG. 1 and performs learning processing to construct dictionary data corresponding to each of objects in different classes by using the training data.

The neural network processing unit 508 is configured of a graphic processing unit (GPU), a digital signal processor (DSP), or the like. Also, the dictionary data that is a result of the learning processing performed by the neural network processing unit 508 is held by the recording unit 506.

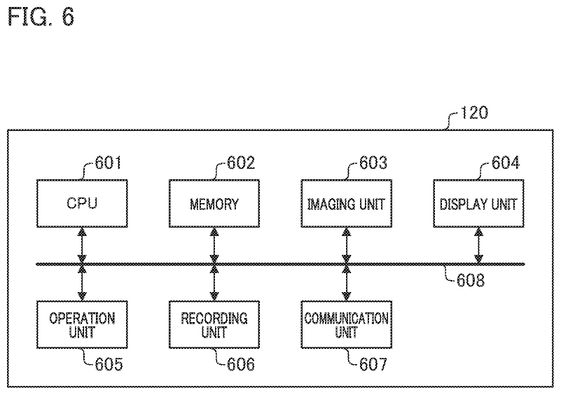

FIG. 6 is a block diagram illustrating a hardware configuration example of the mobile terminal 120. As illustrated in FIG. 6, the mobile terminal 120 includes a CPU 601, a memory 602, an imaging unit 603, a display unit 604, an operation unit 605, a recording unit 606, a communication unit 607, and an internal bus 608.

Some of the functional blocks illustrated in FIG. 6 are realized by causing the CPU 601 as a computer included in the mobile terminal 120 to execute computer programs stored in the recording unit 606 or the like as a storage medium. However, some or all of them may be realized by hardware. As the hardware, it is possible to use an application specific integrated circuit (ASIC) or a processor (a reconfigurable processor, a DSP).

The CPU 601 controls all the processing blocks configuring the mobile terminal 120 by executing the computer programs stored in the recording unit 606. The memory 602 is a memory used mainly as a work area for the CPU 601 and a temporary buffer region of data. Programs such as an operation system (OS) and application software are deployed on the memory 602 and are executed by the CPU 601.

The imaging unit 603 includes an optical lens, a CMOS sensor, a digital image processing unit, and the like, captures an optical image input via the optical lens, converts the optical image into digital data, and thereby acquires captured image data. The captured image data acquired by the imaging unit 603 is temporarily stored in the memory 602 and is processed on the basis of control of the CPU 601.

For example, recording on a recording medium by the recording unit 606, transmission to an external device by the communication unit 607, and the like are performed. Moreover, the imaging unit 603 also includes a lens control unit and performs control such as zooming, focusing, and aperture adjustment on the basis of a command from the CPU 601.

The display unit 604 is configured of a liquid crystal panel, an organic EL panel, or the like and performs display on the basis of an instruction from the CPU 601. The display unit 604 displays an operation screen, a captured image, and the like in order to select an image of the training data from the captured image and designate a network structure.

The operation unit 605 is configured of a keyboard, a mouse, a button, a cross key, a touch panel, a remote controller, and the like and receives an operation instruction from the user. Operation information input from the operation unit 605 is transmitted to the CPU 601, and the CPU 601 executes control of each processing block on the basis of the operation information.

The recording unit 606 is a processing block configured of a large-capacity recording medium and stores and reads various kinds of data in and from the recording medium on the basis of an instruction from the CPU 601. The recording medium is configured of, for example, a built-in flash memory, a built-in hard disk, or a detachable memory card.

The communication unit 607 includes an antenna and processing hardware for performing communication of a wireless LAN, a wired LAN, and the like and performs wireless LAN communication based on the IEEE 802.11n/a/g/b scheme, for example. The communication unit 607 establishes connection with an external access point through a wireless LAN and performs wireless LAN communication with other wireless communication devices via the access point.

The communication unit 607 transmits the training data input from the user via the operation unit 605 and the network structure to the server 110. The internal bus 608 is a bus for establishing mutual connection of each processing block in the mobile terminal SP.

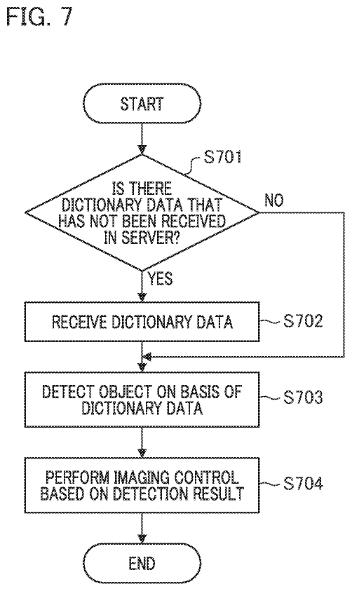

FIG. 7 is a flowchart illustrating processing of the imaging device according to the first embodiment, and a flow of processing in which the imaging device 100 receives dictionary data to be executed, performs object detection, and performs imaging control according to the first embodiment will be described using FIG. 7. The operations are realized by the computer programs stored in the non-volatile memory 203 being deployed on the memory 202 and by the CPU 201 reading and executing the computer programs in the memory 202, in a state where a power source of the imaging device 100 is turned on.

In Step S701, the imaging device 100 checks whether or not there is dictionary data that has not yet been received from the server 110 with the server 110 via the communication unit 218. If there is dictionary data that has not been received from the server 110 in the server 110 (determination of YES is made in Step S701), the dictionary data is acquired from the server 110 via the communication unit 218 and is stored in the non-volatile memory 203 in Step S702. If there is no dictionary data that has not been received from the server 110 (determination of NO is made in Step S701), the processing proceeds to Step S703.

In Step S703, the neural network processing unit 205 performs object detection by using the dictionary data recorded in the non-volatile memory 203. The dictionary data may be copied from the non-volatile memory 203 to the memory 202 or the internal memory 304 of the neural network processing unit 205 and may be used for the object detection. Also, the object detection in Step S703 is performed by using image data acquired by the imaging unit 212 as input data.

In Step S704, the imaging unit 212 performs imaging control such as auto focusing on the basis of a result of the object detection. In other words, imaging control such as auto focusing and exposure control is performed such that the detected object is focused on and appropriate exposure is obtained. Here, Steps S703 and S704 function as an imaging step of performing object detection on the basis of the dictionary data and performs predetermined imaging control on an object detected through the object detection.

In the present embodiment, the step of acquiring the dictionary data from the server and the object detection and the imaging control based on the acquired dictionary data are performed in the same flow. However, the present invention is not limited thereto, and a mode or a timing of making an inquiry to the server and acquiring the dictionary data in advance at the non-imaging time may be provided.

Also, in regard to the dictionary data used for the object detection, it is not always necessary to make the inquiry to the server, to acquire dictionary data that has not yet been acquired, and to use it as it is. For example, as a step of determining dictionary data before the dictionary data is used (for example, before Step S704), a step of receiving a user's operation or a step of automatically making determination, for example, may be provided.

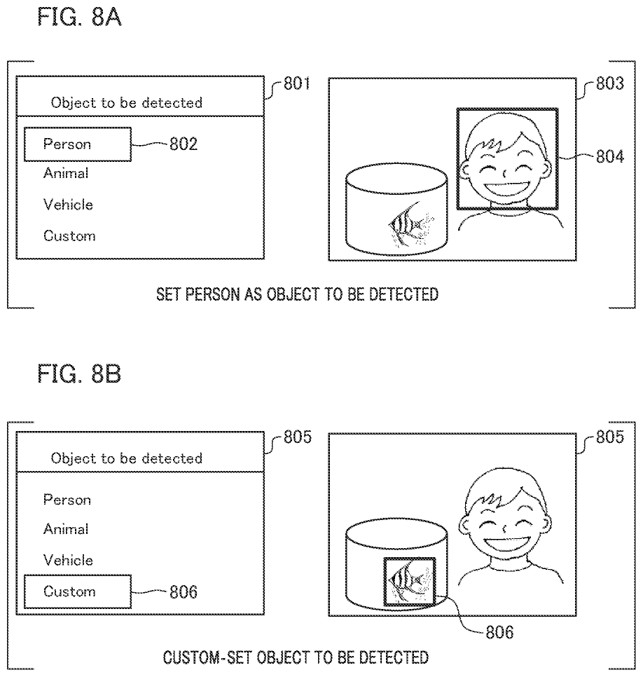

FIGS. 8A and 8B are diagrams for explaining an example of the object detection based on the dictionary data. The dictionary data in the first embodiment includes, for each type of object, the computer programs describing processing content to execute object detection tasks by the neural network processing unit 205 and the learned coefficient parameters. Examples of the type of the object include persons, animals such as dogs and cats, and vehicles such as automobiles and motorcycles.

In FIGS. 8, 801 and 805 illustrate examples of a menu screen on the display unit 216, and the user sets an object to be detected via the operation unit 204. In FIG. 8A, “person” 802 is set as an object to be detected. In the case where “person” is set, object detection is performed by using dictionary data of “person” stored in advance in the non-volatile memory 203. 803 denotes a captured image displayed on the display unit 216, and a state where a “person” face has been detected and a frame 804 is displayed in a superimposed manner.

In FIG. 8B, “custom” 806 is set as an object to be detected. In the case of “custom”, object detection is performed by using “fish”, for example, as dictionary data for custom received from the server 110. 803 is a captured image displayed on the display unit 216, and a state of the case where the dictionary data of “custom” is “fish” in which a frame 806 is displayed in a superimposed manner on a detected fish is illustrated.

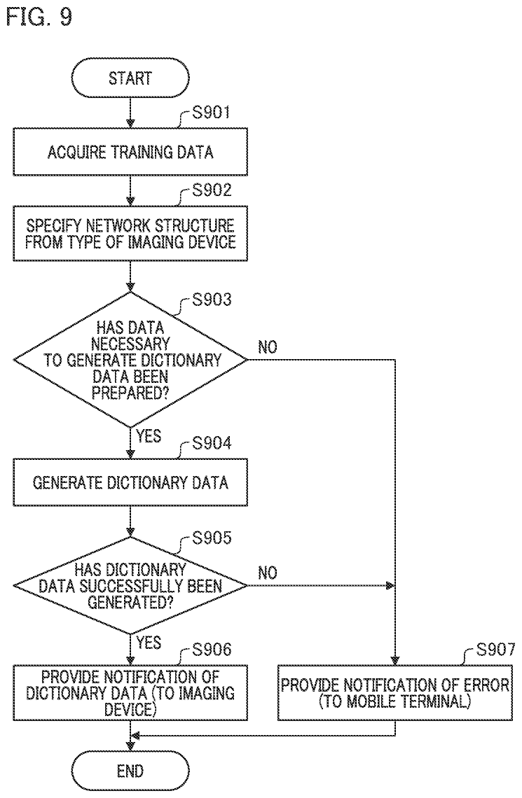

FIG. 9 is a flowchart illustrating processing of the server according to the first embodiment. Note that the processing in FIG. 9 is realized by the computer programs stored in the recording unit 506 being deployed on the memory 502 and by the CPU 501 reading and executing the computer program in the memory 502 in a state where a power source of the server 110 is turned on.

Processing of the server 110 of acquiring training data and information related to a network structure from the mobile terminal 120, generating dictionary data, and transmitting the generated dictionary data to the imaging device 100 will be excerpted and described using FIG. 9.

In Step S901, the server 110 acquires the training data from the mobile terminal 120 via the communication unit 507. Here, Step S901 functions as training data acquisition means (training data acquisition step) of acquiring the training data for the object detection. Also, in Step S902, the information related to the network structure is also acquired from the mobile terminal 120 via the communication unit 507, and the network structure is specified in Step S902.

It is assumed that the information related to the network structure is, for example, a model name of the imaging device, and a correspondence between the model name of the imaging device and the network structure is recorded in the recording unit 506. Step S902 functions as network structure acquisition means (network structure acquisition step) of acquiring the information related to the network structure.

Then in Step S903, whether or not data necessary to generate the dictionary data has been prepared is checked. If the data has been prepared (determination of YES is made in Step S903), the processing proceeds to Step S904. If the data has not been prepared (determination of NO is made in Step S903), the processing proceeds to Step S907. In a case where there is image data in the training data but an object region has not been set, for example, determination of NO is made in Step S903.

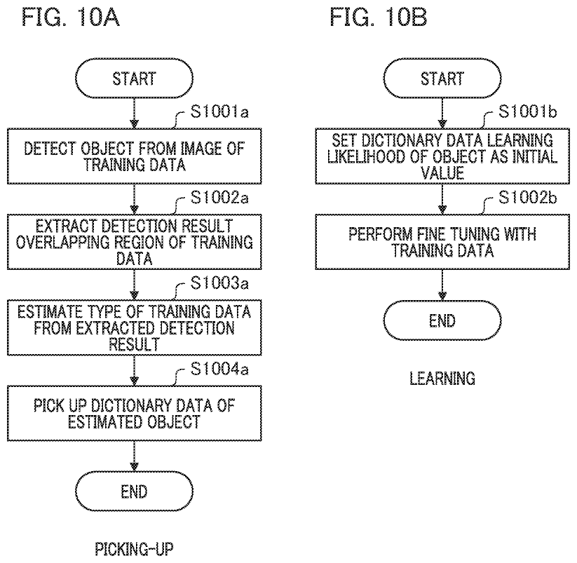

In Step S904, the neural network processing unit 508 generates the dictionary data. As for the generation of the dictionary data, there is a method of generating multiple pieces of dictionary data in advance and selecting appropriate dictionary data from the training data (FIG. 10A, for example), for example. Additionally, a method of generating dictionary data through learning from the training data (FIG. 10B), for example) can also be applied. Step S904 functions as dictionary generation means (dictionary generation step).

FIG. 10 is a flowchart for explaining a flow of dictionary data generation processing according to the first embodiment. FIG. 10A is a flowchart illustrating a flow of the processing in the dictionary data generation example based on selection. In Step S1001a, object detection is performed from image data of the training data. For the object detection described here, it is possible to apply a known object detection method such as YOLO or Fast R-CNN on the assumption that a plurality of types of objects can be detected.

As detection results, position information of xy coordinates, a size, a detection score, an object type, and the like are output. In Step S1002a, a detection result that matches a region of the training data is extracted from region information of the training data and the position information and the size in the result of the object detection. In Step S1003a, the type of the training data is estimated from the extracted detection result. In a case where there are a plurality of pieces of training data, the type of the object is determined from an average value of scores for each type of the object.

In Step S1004a, the estimated dictionary data is picked up. A plurality of pieces of dictionary data are prepared in advance for each type of the network structure, and dictionary data of the target network structure is picked up. Here, Step S1004a functions as dictionary generation means for picking up a dictionary suitable for the object of the training data from the plurality of pieces of dictionary data prepared in advance.

FIG. 10B is a flowchart illustrating a flow of processing in the dictionary generation example based on learning. To perform learning from a state where an initial value of dictionary data is a random number, a large number of pieces of training data are needed. If a large number of pieces of training data are needed, it takes time and efforts for the user to input the training data, and a method of performing learning by using a small number of pieces of training data is desired.

Thus, dictionary data that has learned a variety of objects in advance is set to an initial value in Step S1001b. In Step S1002b, learning is performed on the basis of training data. Since the initial value of the dictionary data is not a random number and is a value obtained by learning a likelihood of an object, so-called fine tuning is performed. Here, Step S1002b functions as dictionary generation means for generating the dictionary by performing learning on the basis of the training data.

Description returns to the flowchart in FIG. 9. Once the dictionary data is generated in Step S904, whether or not the dictionary data has been successfully generated is determined in Step S905. In a case where the dictionary data is generated by the method based on the picking-up as in FIG. 10A, a case where a dictionary can be selected is regarded as success, while a case where a dictionary cannot be selected, such as a case where it is not possible to obtain a result of detection belonging to the training data, is regarded as a failure. Also, in a case where the dictionary data is generated by the method based on the learning as in FIG. 10B, a case where a value of a learning loss function is equal to or less than a predetermined threshold value is regarded as success, while a case where the learning loss function is greater than the predetermined threshold value is regarded as a failure, for example.

If the dictionary data is successfully generated (determination of YES is made in Step S905), the dictionary data is transmitted to the imaging device 100 via the communication unit 507 in Step S906. Here, Step S906 functions as dictionary data transmission means (dictionary data transmission step) of transmitting the dictionary data generated by the dictionary generation means to the imaging device 100. If the generation of the dictionary data is failed (determination of NO is made in Step S905), a notification that an error has occurred is provided to the mobile terminal 120 via the communication unit 507 in Step S907.

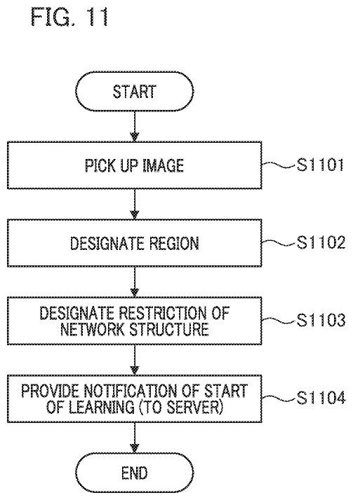

FIG. 11 is a flowchart illustrating an example of a flow of processing executed by the mobile terminal 120 according to the first embodiment. Processing of the mobile terminal 120 in which the mobile terminal 120 inputs training data and information related to a network structure and provides a notification of a start of learning to the server 110 will be excerpted and described.

The operation is realized by the computer programs stored in the recording unit 606 being deployed on the memory 602 and by the CPU 601 reading and executing the computer program in the memory 602 in a state where a power source of the mobile terminal 120 is turned on.

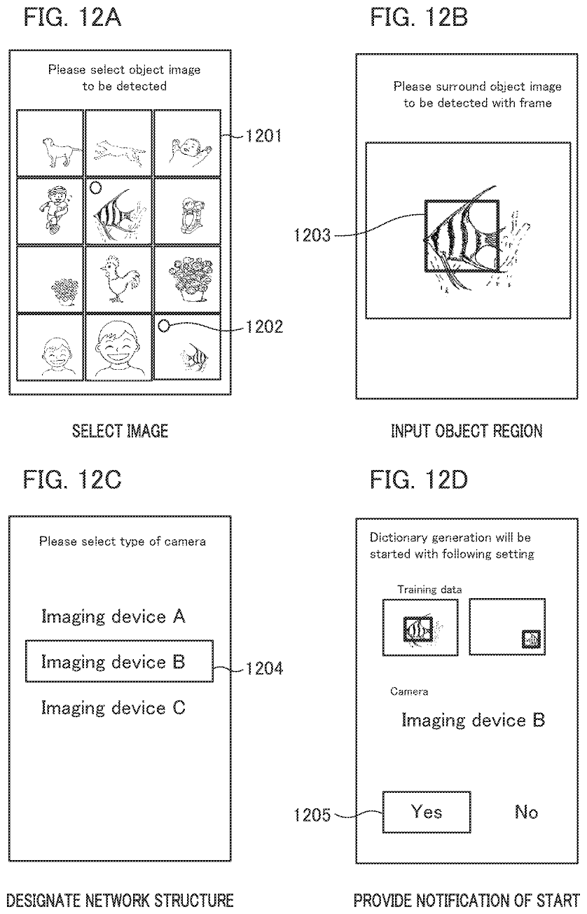

A flow of the processing in the flowchart in FIG. 11 will be described using FIG. 12. FIGS. 12A to 12D are diagrams for explaining an input screen example of training data and a network structure on the display unit 604 of the mobile terminal according to the first embodiment.

In Step S1101 in FIG. 11, the user selects an image to be used as training data from captured images stored in the recording unit 606 via the operation unit 605. FIG. 12A is a diagram illustrating an example of an image selection screen on the display unit 604, and twelve captured images are displayed as illustrated as 1201.

The user selects two pieces of training data, for example, by performing touching or the like on the operation unit 605 from among the twelve captured images. The captured images with display of circles at the left upper corners like 1202 are selected images of the training data.

In Step S1102, the user designates target object regions in in images, which are the two images selected as training image data, via the operation unit 605. FIG. 12B is a diagram illustrating an example of an input screen of an object region of the display unit 604, and the rectangular frame of 1203 illustrates an object region input by the user.

An object region is set for each of the images selected as the training data. As a method of setting the object region, a region selection may be directly performed from an image displayed via a touch panel which is a part of the operation unit 605 and is integrated with the display unit 604. Alternatively, the object region may be selected by performing selection from an object frame simply detected on the basis of feature amounts such as edges by the CPU 601, performing fine adjustment, and the like.

In Step S1103, the user designates restriction of the network structure (designates information related to the network structure) via the operation unit 605. Specifically, the user picks up a type of the imaging device, for example. FIG. 12C is a diagram illustrating an example of an input screen of the network structure on the display unit 604 and illustrates a plurality of model names of imaging devices. The user selects one model name of the imaging device, on which the user desires to perform imaging control by using dictionary data, among these. It is assumed that 1204 is selected.

In Step S1104, the user determines to start generation of the dictionary data via the operation unit 605. FIG. 12D is a diagram illustrating an example of a dictionary data generation start check screen on the display unit 604, and YES or NO is input thereto. If YES illustrated as 1205 is selected, training data and information regarding the type of the imaging device are transmitted to the server 110 via the communication unit 607, and dictionary data is generated by the server 110. If NO is selected in FIG. 12D, the processing is ended.

Note that the object region in the image data of the training data is dealt as a positive instance, and the other regions are dealt as negative instances, in the generation of the dictionary data by the server 110. Although the example in which the image where the object region is present is selected has been described in the above description, an image where no object region is present may be selected. In such a case, the information regarding the object region is not input, and the entire image is dealt as a negative instance.

As described above, according to the imaging system of the first embodiment, it is possible to enable the user to generate arbitrary dictionary data that can be used by an imaging device.

### Second Embodiment

An imaging system according to a second embodiment of the present invention will be described below in detail. Description of parts similar to those in the first embodiment will be omitted.

FIG. 13 is a diagram illustrating a configuration example of the imaging system according to the second embodiment, and the imaging system includes an imaging device 100, a server 110 as an information processing device, and a mobile terminal 120 as an information input device. Also, the imaging device 100, the server 110, and the mobile terminal 120 are connected by a wireless communication network.

It is also possible to enable a user to generate dictionary data for arbitrary (custom) object detection by using predetermined application software installed in the mobile terminal 120 by a method similar to that of the first embodiment in the second embodiment as well.

However, it is assumed that the imaging device 100 can validate a service of generating custom dictionary data (which is referred to as a user custom dictionary) of the user through charging in the second embodiment. According to the charging service, it is not possible to determine a value of the dictionary data if it is not possible to check whether the user custom dictionary is generated as intended.

Thus, the imaging device 100 displays, as a frame, a detection result based on the user custom dictionary. It is thus possible to evaluate detection ability. According to the charging system, an imaging control function using the user custom dictionary is validated (becomes available) by purchasing the dictionary data in the imaging device 100.

The mobile terminal 120 includes a dictionary validating unit 123. Once the user custom dictionary is validated through charging performed by the mobile terminal 120, the imaging device 100 can perform imaging control based on the result of the object detection by using the user custom dictionary. Here, the dictionary validating unit 123 functions as dictionary validation means for validating the dictionary data generated by the dictionary generation means through charging.

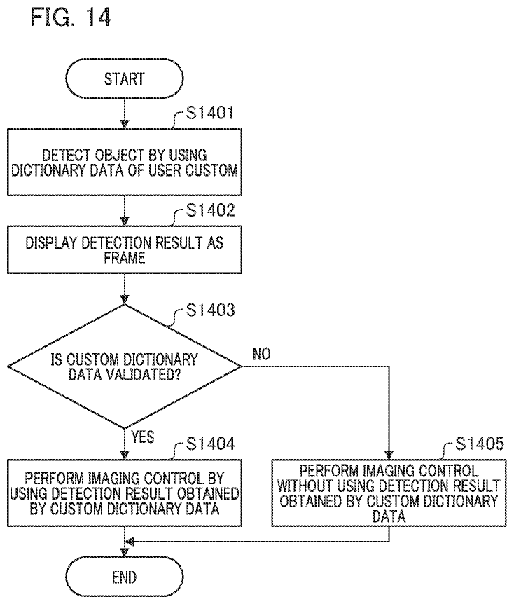

FIG. 14 is a flowchart illustrating a processing example of the imaging device according to the second embodiment, and a flow of processing executed by the imaging device 100 according to the second embodiment will be described using FIG. 14. Operations of the flowchart are realized by computer programs stored in a non-volatile memory 203 being deployed in a memory 202 and by a CPU 201 reading and executing the computer programs in the memory 202 in a state where a power source of the imaging device 100 is turned on.

In Step S1401, a neural network processing unit 205 performs object detection by using user custom dictionary. Note that it is assumed that the imaging device 100 is set to a state where it uses a custom dictionary as described in FIG. 8B.

In Step S1402, a display control unit 215 displays a result of the object detection as a frame on a display unit 216 as display means in a superimposed manner on an image captured by an imaging device. In this manner, a user can check whether or not the dictionary data for the object detection has been generated as intended by the user. In a state where a target object has been detected and nothing other than the target object has been detected, it is possible to evaluate that the dictionary data intended by the user has been able to be generated.

If the dictionary data for the object detection is not generated as intended by the user, the user may add training data and regenerate dictionary data by the mobile terminal 12. In other words, the result of the object detection may be displayed, and a screen for selecting whether or not to move on to a dictionary data regeneration flow (FIG. 11) may be displayed in Step S1402.

In Step S1403, the CPU 201 determines whether or not the user custom dictionary is in a valid state. An initial state of the user custom dictionary is an invalid state, and the state is changed to a valid state by the mobile terminal 120. If processing of validating the dictionary data through charging is executed on the mobile terminal 120 via the operation unit 605, a notification thereof is provided to the imaging device 100 via the communication unit 607.

If the user custom dictionary is in a valid state in Step S1403, imaging control using the detection result based on the dictionary data is performed in Step S1404. If the user custom dictionary is in an invalid state in Step S1403, imaging control is performed without using the detection result based on the dictionary data in Step S1405.

In other words, in a case where the dictionary data has been validated by the dictionary validation means, the imaging device 100 performs predetermined imaging control (AF, AE, and the like) based on the user custom dictionary data on the object detected through the object detection. Also, in a case where the dictionary data has not been invalidated by the dictionary validation means, the imaging device 100 is controlled not to perform the predetermined imaging control based on the user custom dictionary data.

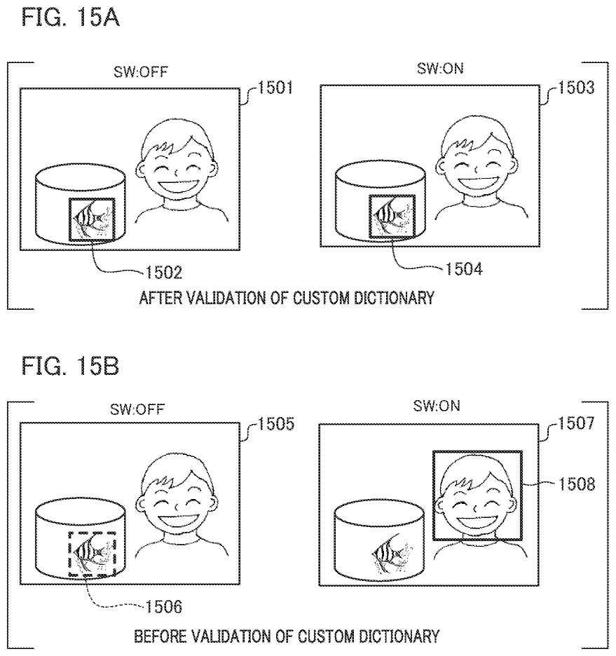

FIG. 15 is a diagram for explaining imaging control before and after validation of the user custom dictionary, and FIG. 15A is an example of captured images on the display unit 216 after the validation of the user custom dictionary. In regard to a captured image 1501, a stationary image recording switch of the imaging device 100 is in an OFF state, and an object detection result 1502 based on the user custom dictionary is displayed as a frame in a superimposed manner on the image captured by the imaging device.

In regard to a captured image 1503, a state where the stationary image recording switch of the imaging device 100 has been turned on and imaging control such as auto focusing and exposure control has been performed on the basis of an object detection result 1504 using the user custom dictionary is illustrated.

FIG. 15B is an example of captured images on the display unit 216 before validation of the user custom dictionary. In regard to a captured image 1505, the stationary image recording switch of the imaging device 100 is in an OFF state, and an object detection result 1506 based on the user custom dictionary is displayed as a frame in a superimposed manner on the image captured by the imaging device.

Here, the object detection result 1502 is illustrated by a solid line in FIG. 15A, while the object detection result 1506 is illustrated by a dashed line. This is for making it easy for the user to confirm that the user custom dictionary has not yet been validated (invalid). Note that this is not limited to the solid line and the dashed line, and the shapes, the colors, and the like of the frame may be changed.

For the captured image 1507, a state where the stationary image recording switch of the imaging device 100 has been turned on and imaging control such as auto focusing and exposure control has been performed on the basis of an object detection result 1508 which is different from the user custom dictionary is illustrated. In the captured image 1507, user dictionary data related to “person” faces which is different from the user custom dictionary is used, and a frame is displayed as the object detection result 1508 in a superimposed manner on the person's face.

Although the case where the number of types of the user custom dictionary is one has been described in the above description, the number of types is not limited to one, and a plurality of types may be set. In such a case, validating/invalidating processing is applied depending on charging for each user custom dictionary. In other words, the dictionary validation means performs validation of each piece of dictionary data through charging in a case where there are a plurality of pieces of dictionary data generated by the dictionary generation means.

Also, although the example in which the validation/invalidation of the user custom dictionary is a target of charging has been described in the above description, this can also be established for existing dictionary data that has been created by a service provider and has been registered in advance in a device or a server as a service of adding a dictionary through charging. In other words, valid and invalid setting may be able to be performed by the dictionary validation means on the existing dictionary data stored in advance in a memory in each device or the server 110.

As described above, according to the imaging system of the second embodiment, it is possible to check object detection performance of acquired dictionary data on the imaging device 100 and then determine whether to purchase the dictionary data. Also, it is possible to check whether or not the object detection performance of the dictionary data is sufficient, thereby to provide training data again, and to further enhance the object detection performance of the created dictionary.

### Third Embodiment

An imaging system according to a third embodiment of the present invention will be described below in detail. Description of parts similar to those in the first embodiment will be omitted.

FIG. 16 is a configuration diagram of the imaging system according to the third embodiment, and the imaging system according to the third embodiment is a system including an imaging device 100 and a server 110 as an information processing device, and the imaging device 100 and the server 110 are connected by a wireless communication network. A difference from the first embodiment is that the mobile terminal 120 as an information processing terminal is not present and the imaging device 100 plays a role in inputting training data and a network structure.

The imaging system according to the first embodiment enables the user to generate arbitrary dictionary data. However, it is necessary for the user to create training data, and it takes time and effort. In order to solve such time and effort, the third embodiment is configured to assist the creation of the training data. In other words, the imaging system according to the third embodiment includes a training data generation unit 103 as training data generation means in the imaging device 100, and the user inputs training data by a training data input unit 121 on the basis of the result.

The training data generation unit 103 utilizes an inference result of the object detection unit 101 (neural network processing unit 205). Processing content of processing of the object detection unit 101 (neural network processing unit 205) differs in a case where processing is performed for imaging control at the time of imaging and a case where processing is performed for generating training data at the non-imaging time. Details will be described later.

In the imaging system according to the first embodiment, the network structure designation unit 122 is included in the mobile terminal 120 which is different from the imaging device, and the imaging system is configured such that the user designates a model name of the imaging device since restriction of the network structure differs depending on a model of the imaging device.

On the other hand, in the imaging system according to the third embodiment, a network structure designation unit 122 is included in the imaging device 100, a CPU 201 of the imaging device 100 instead of the user designates a network structure and provides a notification to the server 110 via a communication unit 218. In other words, a communication step of transmitting training data input by the training data input unit 121 and the network structure designated by the network structure designation unit 122 to the information processing server is included.

Note that some of functional blocks illustrated in FIG. 16 are realized by the CPU 201 as a computer included in the imaging device 100 to execute computer programs stored in a non-volatile memory 203 or the like as a storage medium. However, some or all of them may be realized by hardware. As the hardware, it is possible to use an application specific integrated circuit, a processor (a reconfigurable processor, a DSP), or the like.

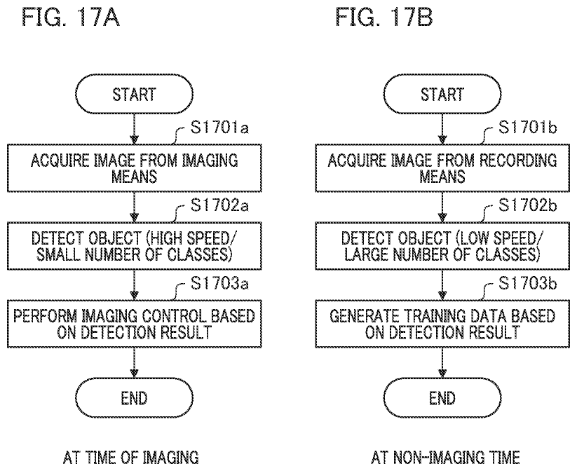

FIG. 17 is a flowchart for explaining processing of the imaging device 100 according to the third embodiment. A flow of processing will be described by focusing on differences in neural network processing for imaging control at the time of imaging and for training data transmission at the non-imaging time of the imaging device 100 according to the third embodiment using FIG. 17. FIG. 17A is a flowchart illustrating a flow of the processing at the time of imaging, and FIG. 17B is a flowchart illustrating a flow of the processing at the non-imaging time.

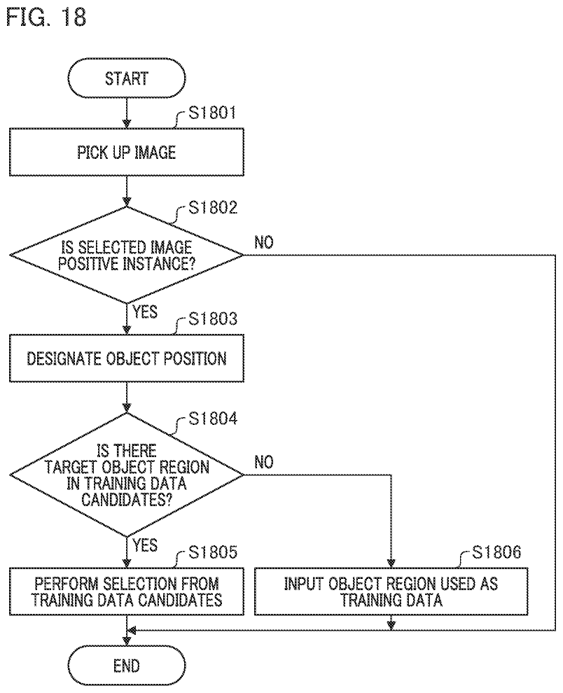

These operations are realized by the computer programs stored in the non-volatile memory 203 being deployed on the memory 202 and by the CPU 201 reading and executing the computer programs in the memory 202 in a state where a power source of the imaging device 100 is turned on. The same applies to the flowchart in FIG. 18, which will be described later.

In the processing at the time of the imaging in FIG. 17A, an image is acquired from imaging means in Step S1701a. The image is used to perform object detection by an object detection unit 101 (neural network processing unit 205) in Step S1702a. In Step S1703a, the imaging control unit 102 performs imaging control on the basis of the detection result. Since the object detection result is used in the imaging control such as auto focusing, it is necessary to process the object detection at a high speed in the object detection unit 101 (neural network processing unit 205).

In order to perform high-speed processing, a type of an object to be detected is limited. As described above using FIG. 8, for example, the object to be detected is selected in menu setting, and dictionary data for detecting only the selected object is used. Since only a small number of parameters are needed to express features of the object and the number of times product-sum operation is performed to extract the features is reduced by limiting the object to be detected, it is possible to perform high-speed processing.

On the other hand, an image is acquired from the recording medium 220 as recording means, the server, or the like in Step S1701b in the processing at the non-imaging time in FIG. 17B. The image is used to perform object detection by the object detection unit 101 (neural network processing unit 205) in Step S1702b. Training data is generated on the basis of the detection result in Step S1703b.

Since creation of arbitrary training data by the user is a goal, it is necessary to detect various objects in the object detection performed by the object detection unit 101 (neural network processing unit 205) in Step S1703b. In order to detect various objects, it is necessary to increase the number of parameters expressing features of objects, and the number of times the product-sum operation is performed to extract the features increases. Therefore, processing is performed at a low speed.

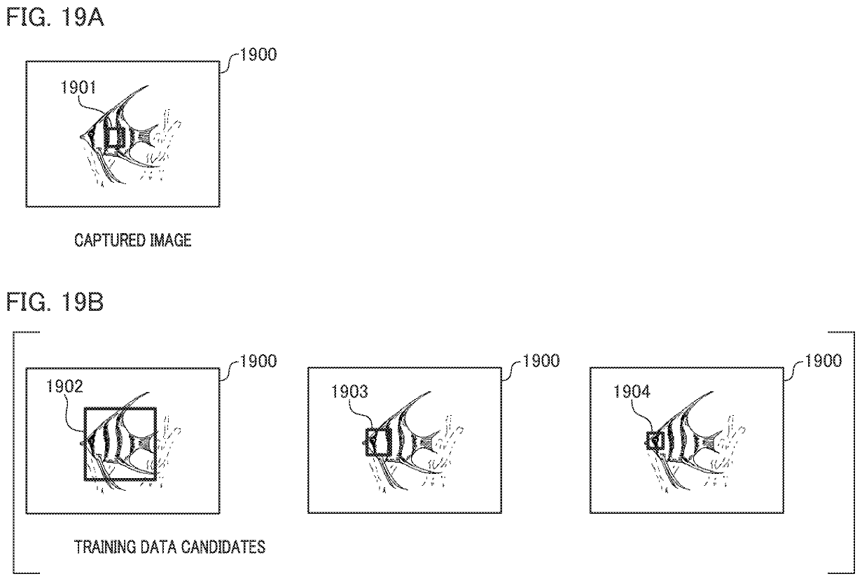

FIG. 18 is a flowchart for explaining a flow of training data input processing in FIG. 17B. Also, FIGS. 19A and 19B are diagrams illustrating an example of a training data input screen in FIG. 18. An input of the training data is performed by the user performing an input via the operation unit 204 on the basis of information displayed on a screen 1900 (FIG. 19) of the display unit 216 of the imaging device 100.

In Step S1801, the user selects an image to be used for the training data from captured images recorded in the recording medium 220. In Step S1802, the user selects which of a positive instance and a negative instance the selected image corresponds to. If the target object is present in the selected image, the positive instance is selected, and the processing proceeds to Step S1803.

On the other hand, if the target object is not present in the selected image, the negative instance is selected, and the processing is ended. In this case, the entire image is dealt as a region of a negative instance. For example, this is used when an object that is not desired to be detected is selected.

In Step S1803, the position of the target object is designated on the selected image. In a case where the operation unit 204 is a touch panel, for example, the position of the target object can be designated by touching. A focusing region at the time of imaging may be used as an initial value of the position of the object. In FIG. 19A, 1901 is the selected image, and 1902 illustrates an example of the designated position.

In Step S1804, the screen 1900 of the display unit 216 is caused to display training data candidates, and whether or not there is a target object region is checked. Object regions that are close to the designated position are regarded as training data candidates on the basis of the object detection result of the neural network processing unit 205. FIG. 19B illustrates an example of the training data candidates. An example of three training data candidates which are the same as an object but correspond to different regions is illustrated. An entire body, a face, and a pupil are regarded as training data candidates as indicated in 1902, 1903, and 1904, respectively.

If there is a target object region from among the training data candidates in Step S1804, the processing proceeds to Step S1805, and one of the training data candidates is regarded as a positive region of the training data. If there is no target object region from among the training data candidates in Step S1804, the processing proceeds to Step S1806, and the user inputs an object region to be used as training data.

As described above, according to the imaging system of the third embodiment, it is possible to generate training data by using the imaging device 100 itself and to reduce a burden on the user to generate the training data.

### Other Embodiments

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

Targets to which the present invention may be applied are not limited to the imaging device 100, the server 110, the mobile terminal 120, and the like described in the above embodiments. For example, it is possible to realize functions similar to those in the aforementioned embodiments even in a case of a system in which the imaging device 100 is configured of a plurality of devices. Furthermore, a part of the processing of the imaging device 100 can be performed and realized by an external device on a network.

Note that in order to realize a part or entirety of the control in the present embodiments, computer programs that realize the functions of the aforementioned embodiments may be supplied to the imaging system and the like via a network or various storage media. Also, a computer (or a CPU or an MPU) in the imaging system and the like may read and execute the programs. In such a case, the programs and the storage media storing the programs configure the present invention.

### CROSS-REFERENCE OF RELATED APPLICATIONS

The present application claims benefits of Japanese Patent Application No. 2021-168738 filed Oct. 14, 2021 previously applied. Also, entire content of the above Japanese patent application is incorporated in the specification by reference.

1. An imaging system that performs object detection on the basis of a neural network, the imaging system comprising:
at least one processor or circuit configured to function as:
training data input unit configured to input training data for the object detection;
network structure designation unit configured to designate information related to a network structure in the object detection;
dictionary generation unit configured to generate dictionary data for the object detection on the basis of the training data and the information related to the network structure; and
an imaging device configured to perform the object detection on the basis of the dictionary data generated by the dictionary generation unit and performs predetermined imaging control on an object detected through the object detection.

2. The imaging system according to claim 1, wherein the imaging unit includes a communication unit configured to receive the dictionary data and performs the object detection on the basis of the dictionary data received by the communication unit.

3. The imaging system according to claim 1, wherein the information related to the network structure includes information related to at least one of an image size of input data, a number of channels of the input data, a number of parameters of a network, a memory capacity, a type of a layer and a type of an activation function, and a product-sum operation specification.

4. The imaging system according to claim 1, wherein the dictionary generation unit is included in an information processing server that is different from the imaging device.

5. The imaging system according to claim 4,
wherein the information processing server includes
at least one processor or circuit configured to function as:
training data acquisition unit configured to acquire the training data for the object detection,
network structure acquisition unit configured to acquire information related to the network structure,
the dictionary generation unit, and
dictionary data transmission unit configured to transmit the dictionary data generated by the dictionary generation unit to the imaging device.

6. The imaging system according to claim 1, wherein the dictionary generation unit is configured to select a dictionary suitable for an object of the training data from among a plurality of pieces of the dictionary data prepared in advance.

7. The imaging system according to claim 1, wherein the dictionary generation unit is configured to generate the dictionary data by performing learning on the basis of the training data.

8. The imaging system according to claim 1, wherein the training data input unit and the network structure designation unit are included in an information processing terminal that is different from the imaging device.

9. The imaging system according to claim 1, wherein the training data includes image data and region information of the image data where a target object is present.

10. The imaging system according to claim 1, wherein the network structure designation unit is configured to designate the network structure by designating a model of the imaging device.

11. The imaging system according to claim 1, wherein the at least one processor or circuit is further configured to function as,
dictionary validation unit configured to validate the dictionary data generated by the dictionary generation unit,
wherein in a case where the dictionary data has been validated by the dictionary validation unit, the imaging device is configured to perform the predetermined imaging control on the object detected through the object detection, and
in a case where the dictionary data has not been validated by the dictionary validation unit, the imaging device is configured not to perform the predetermined imaging control.

12. The imaging system according to claim 1, further comprising:
display unit that displays a result of the object detection as a frame in a superimposed manner on an image from the imaging device.

13. The imaging system according to claim 11, wherein the dictionary validation unit is configured to validate the dictionary data through charging.

14. The imaging system according to claim 11, wherein the dictionary validation unit is configured to validate each piece of dictionary data through charging in a case where there is a plurality of pieces of the dictionary data generated by the dictionary generation unit.

15. The imaging system according to claim 1, wherein the imaging device includes training data generation unit configured to generate the training data.

16. An imaging device that performs object detection on the basis of a neural network, the imaging device comprising:
at least one processor or circuit configured to function as:
training data input unit configured to input training data for the object detection;
network structure designation unit configured to designate information related to a network structure in the object detection;
communication unit configured to transmit the training data and the information related to the network structure to an information processing server; and
imaging control unit configured to acquire dictionary data for the object detection generated on the basis of the training data and the information related to the network structure in the information processing server from the information processing server via the communication unit, performing the object detection on the basis of the dictionary data, and performing predetermined imaging control on an object detected through the object detection.

17. The imaging device according to claim 16, wherein the information related to the network structure includes information related to at least one of an image size of input data, a number of channels of the input data, a number of parameters of a network, a memory capacity, a type of a layer and a type of an activation function, and a product-sum operation specification.

18. The imaging device according to claim 16, further comprising:
display unit that displays a result of the object detection as a frame in a superimposed manner on an image.

19. An information processing server comprising:
at least one processor or circuit configured to function as:
training data acquisition unit configured to acquire training data for object detection;
network structure acquisition unit configured to acquire information related to a network structure of an imaging device;
dictionary generation unit configured to generate dictionary data for the object detection on the basis of the training data and the information related to the network structure; and
dictionary data transmission unit configured to transmit the dictionary data generated by the dictionary generation unit to the imaging device.

20. The information processing server according to claim 19, wherein the dictionary generation unit is configured to pick up a dictionary suitable for an object of the training data from a plurality of pieces of the dictionary data prepared in advance.

21. The information processing server according to claim 19, wherein the dictionary generation unit is configured to generate the dictionary data by performing learning on the basis of the training data.

22. The information processing server according to claim 19, wherein the training data and the information related to the network structure are acquired from the imaging device or an information processing terminal that is different from the imaging device.

23. The information processing server according to claim 19, wherein the information related to the network structure includes information related to at least one of an image size of input data, a number of channels of the input data, a number of parameters of a network, a memory capacity, a type of a layer and a type of an activation function, a product-sum operation specification, and a model of the imaging device.

24. An imaging method of performing object detection on the basis of a neural network, the method comprising:
inputting training data for the object detection;
designating information related to a network structure in the object detection;
generating dictionary data for the object detection on the basis of restriction of the training data and the network structure; and
performing the object detection on the basis of the dictionary data and performing predetermined imaging control on an object detected through the object detection.

25. An imaging method of performing object detection on the basis of a neural network, the method comprising:
inputting training data for the object detection;
designating information related to a network structure in the object detection;
transmitting the training data and the information related to the network structure to an information processing server; and
acquiring dictionary data for the object detection generated on the basis of the training data and the information related to the network structure in the information processing server from the information processing server,
performing the object detection on the basis of the dictionary data, and
performing predetermined imaging control on an object detected through the object detection.

26. An information processing method comprising:
acquiring training data for object detection;
acquiring information related to a network structure of an imaging device;
generating dictionary data for the object detection on the basis of the training data and the information related to the network structure; and
transmitting the dictionary data to the imaging device.

27. A storage medium that stores a computer program for executing an imaging method of performing object detection on the basis of a neural network, the imaging method comprising the following steps:
inputting training data for the object detection;
designating information related to a network structure in the object detection;
generating dictionary data for the object detection on the basis of restriction of the training data and the network structure; and
performing the object detection on the basis of the dictionary data and
performing predetermined imaging control on an object detected through the object detection.

28. A storage medium that stores a computer program for executing an imaging method of performing object detection on the basis of a neural network, the imaging method comprising the following steps:
inputting training data for the object detection;
designating information related to a network structure in the object detection;
transmitting the training data and the information related to the network structure to an information processing server; and
acquiring dictionary data for the object detection generated on the basis of the training data and the information related to the network structure in the information processing server from the information processing server,
performing the object detection on the basis of the dictionary data, and
performing predetermined imaging control on an object detected through the object detection.

29. A storage medium that stores a computer program for executing an information processing method, the information processing method comprising the following steps:
acquiring training data for object detection;
acquiring information related to a network structure of an imaging device;
generating dictionary data for the object detection on the basis of the training data and the data related to the network structure; and
transmitting the dictionary data to the imaging device.
